(19) United States
(12) Patent Application Publication
(10) Pub. No.: US 2020/0137321 A1
(43) Pub. Date: Apr. 30, 2020

(54) Pulsating Image

(71) Applicant: SOURCICO LTD., Tel Aviv (IL)

(72) Inventor: Ilan Aroush, Herzlia (IL)

(21) Appl. No.: 16/619,612

(22) PCT Filed: Jun. 17, 2018
(86) PCT No.: PCT/IB2018/054445

§ 371 Date: Dec. 5, 2019

Related U.S. Application Data
(60) Provisional application No. 62/525,774, filed on Jun. 28, 2017.

(51) Int. Cl. H04N 5/262; H04N 5/232

(52) U.S. Cl. CPC H04N 5/2627; H04N 5/23254; H04N 5/2624

(57) ABSTRACT

A system for creating a pulsating image, comprising an electronic device comprising a camera and configured to communicate with a storage; a designated application running on the electronic device; the designated application comprises: a capturing module configured to communicate with the camera and receive a micro video having predetermined characteristics upon a user request; and a packetizing module configured to receive the micro video, create a pulsating image and a pulsating thumbnail of the pulsating image out of the micro video and packetize the pulsating image and the pulsating thumbnail.

### CROSS-REFERENCE TO RELATED PATENT APPLICATIONS

This patent application claims priority from and is related to U.S. Provisional Patent Application Ser. No. 62/525,774, filed Jun. 28, 2017, this U.S. Provisional Patent Application incorporated by reference in its entirety herein.

### FIELD OF THE INVENTION

The present invention generally relates to digital photography and specifically to a pulsating image a revived living image.

### BACKGROUND

Traditional outputs of photographing include still images and videos.

Video capturing requires an operator to start and stop them and relatively large storage space.

Still images are still and do not reflect the experience of the captured moment.

There is a need for replacing the traditional way of capturing still images with a “pulsating image” which provides liveliness and smooth representation of the captured image.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic view of the system according to embodiments of the present invention;

FIG. 2 shows a flowchart of the “pulsating image” creating process performed by the system of the present invention; and

FIG. 3 shows a flowchart of the process performed by the system of the present invention when a user wishes to view a “pulsating image”.

### DETAILED DESCRIPTION OF PREFERRED EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention provides system and method for creating a “pulsating image”. The “pulsating image” is a high resolution very short video (micro video), captured with high frame rate, which is manipulated and looped to create a liveliness effect to the “pulsating image”. According to embodiments of the present invention, the “pulsating image” is captured by a single click, namely, no start and stop clicks, the same way a still image is being captured. According to other embodiments of the present invention, the “pulsating image” may be captured by a start and stop clicks or by a continuous prolonged click.

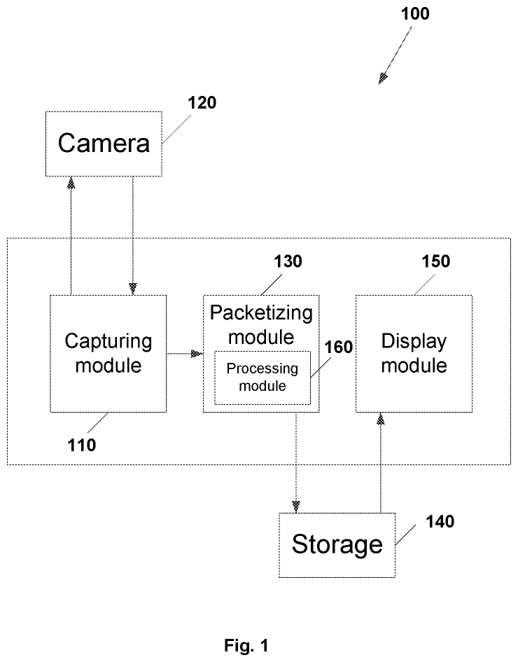

FIG. 1 is a schematic view of the system 100 according to embodiments of the present invention, comprising a capturing module 110 enabling a user to capture the “pulsating image” using an electronic device's camera 120; a packetizing module 130 for receiving the captured image from the capturing module 110, creating a packet including a “pulsating image” file (e.g., an Mpeg_4 file, AVI file, proprietary file, etc.) and a “pulsating thumbnail” file (e.g., Graphics Interchange Format (GIF) file) and saving the packet in the electronic device's storage 140; and a display module 150 for displaying the “pulsating image” according to predefined or selected rules.

It will be appreciated that the storage 140 is not limited to be the storage of the electronic device. According to embodiments of the present invention, the system may communicate with an external storage such as an external hard drive, a cloud, etc.

According to embodiments of the present invention, packetizing module 130 may further comprise a processing module 160 for processing the “pulsating image” as will be explained below.

According to embodiments of the present invention, the packet may include only the “pulsating image”.

The electronic device may be for example, a smartphone, tablet, PDA, a PC, a digital camera or any type of electronic device.

According to embodiments of the present invention, the processing module 160 may be included in the display module 150 for processing the “pulsating image” before displaying.

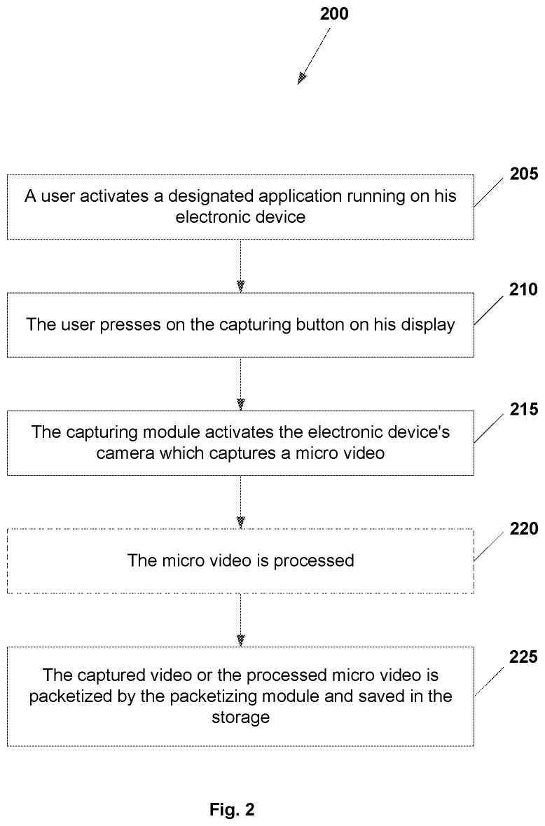

FIG. 2 shows a flowchart 200 of the “pulsating image” creating process performed by the system 100 of the present invention. In step 205, a user activates a designated application running on his electronic device. In step 210, the user presses on the capturing button e.g., on his display. In step 215, the capturing module activates the electronic device's camera which captures a micro video having a predetermined/or adjustable length and frame rate. Optionally, in step 220, the captured micro video is processed. In step 225, the micro video or the processed micro video is packetized by the packetizing module as a “pulsating image” along with the “pulsating thumbnail”, and saved in the storage 140. The “pulsating thumbnail” is presented in the gallery of the designated application.

As mentioned above, it will be appreciated that the packet may include only the “pulsating image”.

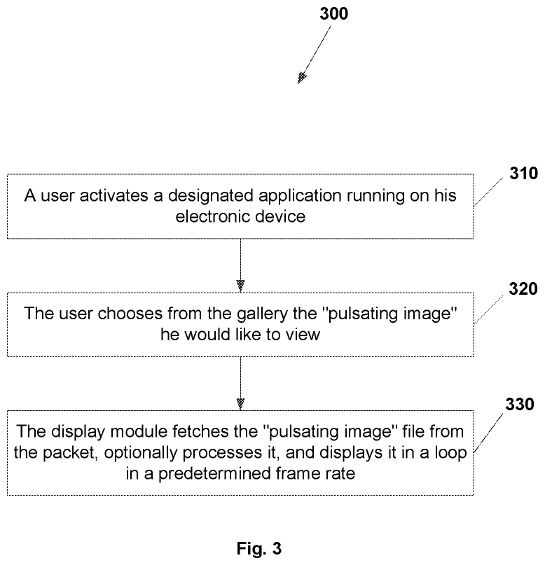

FIG. 3 shows a flowchart 300 of the process performed by the system 100 of the present invention when a user wishes to view a “pulsating image”. In step 310, the user activates the designated application running on his electronic device, whereby the application's gallery is displayed. In step 320, the user chooses from the gallery the “pulsating image” he would like to view. In step 330, the display module 150 fetches the “pulsating image” file from the packet, optionally processes it, and displays it in a loop in a predetermined frame rate and according to predefined or selected rules designed to create smoother eye experience by slowing down some or all of the frames of the “pulsating image”, this slowing down process may be done to any part of the “pulsating image” and not necessarily by slowing down all of the frames to the same speed, i.e., some frames can run faster and some can be slowed down. According to exemplary embodiments of the present invention, the “pulsating image” is captured in 60 fps (frames per second) and displayed in 30 fps.

According to embodiments of the present invention, the rules may be for example, how to loop the “pulsating image”.

According to embodiments of the present invention, the “pulsating image” may be looped by playing the micro video from the beginning till its end and jumping back to the beginning or by playing the micro video from the beginning till its end and from the end backwards to the beginning.

It will be appreciated that the system of the present invention is not limited to include the capturing module 110, the camera 120, the packetizing module 130, the display module 150 and the processing module 160.

According to embodiments of the present invention, the system may include only the capturing module 110, the camera 120, the packetizing module 130 and the storage 140 for the “pulsating image” creation process.

According to embodiments of the present invention, the system may include only the capturing module 110, the camera 120, the packetizing module 130, the processing module 160 and the storage 140 for the “pulsating image” creation process.

According to embodiments of the present invention, the system may include only the display module 150 and the processing module 160 for displaying a “pulsating image”. It will be appreciated that is such a case, the system may display any micro video fetched from storage, e.g., a hard drive, a cloud, etc.

According to embodiments of the present invention, the system may include only the display module 150 for displaying a “pulsating image”. It will be appreciated that is such a case, the system may display any micro video fetched from storage, e.g., a hard drive, a cloud, etc.

According to embodiments of the present invention, the processing module 160 may process the micro video to create a morphing effect that smoothes the transition between the end and the beginning of the created “pulsating image”. The first frame of the micro video and/or the last frame of the micro video may be determined by the system, according to system definitions. If the difference between the first frame and last frame is smaller than a predetermined value, the micro video may be processed to create a morphing effect that smoothes the “pulsating image” by adding frames in addition to the existing frames or instead of some of the frames from the beginning and/or end of the micro video in order to smooth the transition from the end of the “pulsating image” to the beginning of it. According to embodiments of the present invention, the additional frames may be created by marking corresponding points and vectors on the first and last frames used in the morph. For example, morph the face from the last frame into the face from the first frame by marking key points on the first frame's face, such as the contour of the nose or location of an eye; mark where these same points exist on the last frame's face and create frames that smooth the transition between the first and last frames of the “pulsating image”.

For example, assuming the micro video includes 100 frames, the processing module 160 may use frame number 1 as the first frame and frame number 100 as the last frame and add X number of morph frames between frame 100 and frame 1.

In another example, the processing module 160 may use frame number 1 as the first frame and frame number 90 as the last frame. In such a case, frames 91-100 are deleted and the processing module adds Y number of morph frames between frame 90 and frame 1.

It will be appreciated that the processing module 160 may choose any frame as the first frame and any frame as the last frame (as long as the first frame is placed before the last frame) and any number of morph frames may be added.

According to embodiments of the present invention, the determination whether the difference is smaller than the predetermined threshold may be based on several parameters, for example, by comparing the distance of the identified person's face and\or posture in the first and last frames, the location of an object in the first and last frames, etc.

It will be appreciated that the morphing effect may be performed on the micro video when captured or on the “pulsating image” before displaying.

According to embodiments of the present invention, the processing module 160 processes the “pulsating image” to identify the background and the main captured object (e.g., a person) in the “pulsating image”. The identification may be made by identifying the main object or the centered object in the “pulsating image” and separating the object from the rest of the image, using image processing methods known in the art for object detection, such as Viola-Jones object detection. When the background and main object are identified, the display module 150 may freeze the background or the object to create a semi “pulsating image”, namely, freeze the object and allow the background to pulsate or freeze the background and allow the object to pulsate.

According to embodiments of the present invention, the processing module 160 may process the “pulsating image” using known in the art image stabilization methods in order to reduce blurring and/or image shake associated with the motion of the camera during exposure.

According to embodiments of the present invention, the “pulsating images” may be saved on a system server, a hard drive, a cloud, etc.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A system for creating a pulsating image, comprising:
an electronic device comprising a camera and configured to communicate with a storage;
a designated application running on said electronic device;
said designated application comprises:
a capturing module configured to communicate with said camera and receive a micro video comprising a plurality of frames upon a user request;
said micro video having predetermined characteristics and a first frame-per-second rate; and
a packetizing module configured to receive said micro video, create a pulsating image having a second frame-per-second rate and a pulsating thumbnail of said pulsating image out of said micro video and packetize said pulsating image and said pulsating thumbnail;
wherein said system is further configured to slow down said second frame-per-second rate of at least part of said plurality of frames.

2. The system of claim 1, wherein said designated application further comprises a processing module configured to process said micro video for creating said pulsating image.

3. The system of claim 2, wherein said processing module is configured to create a morphing effect by adding frames between a determined last frame and a determined first frame of said micro video.

4. The system of claim 2, wherein said processing module is configured to perform an image stabilization process.

5. The system of claim 2, wherein said processing module is configured to identify at least one main object and a background and to perform at least one of:
freeze said main object and allow said background to pulsate; and
freeze said background and allow said main object to pulsate.

6. (canceled)

7. (canceled)

8. (canceled)

9. A system for displaying a pulsating image, comprising:
an electronic device configured to communicate with a storage;
said storage comprises at least one packet comprising a pulsating image comprising a plurality of frames and a pulsating thumbnail of said pulsating image; and
a designated application running on said electronic device;
said designated application comprises:
a displaying module configured to display a gallery of said at least one pulsating thumbnail representing a pulsating image to be viewed; receive a user selection of a pulsating thumbnail; extract the respective pulsating image according to said selection; and display said selected pulsating image according to predetermined characteristics and a frame-per-second rate;
wherein said display module is further configured to slow down said frame-per-second rate of at least part of said plurality of frames.

10. The system of claim 9, wherein said designated application further comprises a processing module configured to process said pulsating image before displaying.

11. The system of claim 10, wherein said processing module is configured to create a morphing effect by adding frames between a determined last frame and a determined first frame of said pulsating image.

12. The system of claim 10, wherein said processing module is configured to perform an image stabilization process.

13. The system of claim 10, wherein said processing module is configured to identify at least one main object and a background and to perform at least one of:
freeze said main object and allow said background to pulsate; and
freeze said background and allow said main object to pulsate.

14. (canceled)

15. (canceled)

16. The system of claim 9, wherein said predetermined characteristics comprise loop orders; wherein said loop orders comprise one of:
displaying said pulsating image from the beginning till its end and jumping back to the beginning of said pulsating image; and
displaying said pulsating image from the beginning till its end and from the end backwards to the beginning of said pulsating image.

17. (canceled)

18. (canceled)

19. A method of creating a pulsating image, comprising:
providing an electronic device comprising a camera and communicating with a storage;
receiving, by a capturing module from said camera, a micro video comprising a plurality of frames upon a user request;
said micro video having predetermined characteristics and a first frame-per-second rate;
processing, by a processing module, said micro video for creating a pulsating image having a second frame-per-second rate and a pulsating thumbnail of said pulsating image;
packetizing, by a packetizing module, said pulsating image and said pulsating thumbnail of said pulsating image;
wherein said packetizing comprises slowing down said second frame-per-second rate of at least part of said plurality of frames; and
saving said packet in said storage.

20. The method of claim 19, wherein said processing comprises creating a morphing effect by adding frames between a determined last frame and a determined first frame of said micro video.

21. The method of claim 19, wherein said processing comprises performing an image stabilization process.

22. The method of claim 19, wherein said processing comprises identifying at least one main object and a background for performing at least one of:
freezing said main object and allowing said background to pulsate; and
freezing said background and allowing said main object to pulsate.

23. (canceled)

24. (canceled)

25. (canceled)

26. A method of displaying a pulsating image, comprising:
providing an electronic device communicating with a storage;
said storage comprises at least one packet comprising a pulsating image having a frame-per-second rate and a pulsating thumbnail of said pulsating image;
said pulsating image comprises a plurality of frames;
displaying a gallery of said at least one pulsating thumbnail representing a pulsating image to be viewed;
selecting a pulsating thumbnail;
extracting the respective pulsating image according to said selection; and
displaying said respective pulsating image according to predetermined characteristics;
wherein said displaying comprises slowing down said frame-per-second rate of at least part of said plurality of frames.

27. The method of claim 26, further comprising processing by a processing module said pulsating image before displaying.

28. The method of claim 27, wherein said processing comprises creating a morphing effect by adding frames between a determined last frame and a determined first frame of said pulsating image.

29. The method of claim 27, wherein said processing comprises performing an image stabilization process.

30. The method of claim 27, wherein said processing comprises identifying at least one main object and a background for performing at least one of:
freezing said main object and allowing said background to pulsate; and
freezing said background and allowing said main object to pulsate.

31. (canceled)

32. (canceled)

33. The method of claim 26, wherein said predetermined characteristics comprise loop orders; wherein said loop orders comprise one of:
displaying said pulsating image from the beginning till its end and jumping back to the beginning of said pulsating image; and
displaying said pulsating image from the beginning till its end and from the end backwards to the beginning of said pulsating image.

34. (canceled)
